(19) United States
(12) Patent Application Publication
(10) Pub. No.: US 2014/0272689 A1
(43) Pub. Date: Sep. 18, 2014

(54) MAGENTA TONER, DEVELOPER, TONER CARTRIDGE, IMAGE FORMING APPARATUS AND PRINTED MATTER

(71) Applicants: Hiroshi YAMASHITA, Shizouka (JP); Masana SHIBA, Shizouka (JP); Tsuyoshi SUGIMOTO, Shizouka (JP); Daisuke ASAHINA, Shizouka (JP); Susumu CHIBA, Shizouka (JP); Satoyuki SEKIGUCHI, Shizouka (JP)

(72) Inventors: Hiroshi YAMASHITA, Shizouka (JP); Masana SHIBA, Shizouka (JP); Tsuyoshi SUGIMOTO, Shizouka (JP); Daisuke ASAHINA, Shizouka (JP); Susumu CHIBA, Shizouka (JP); Satoyuki SEKIGUCHI, Shizouka (JP)

(21) Appl. No.: 14/190,771

(22) Filed: Feb. 26, 2014

(30) Foreign Application Priority Data
Mar. 13, 2013 (JP) 2013-050190

(51) Int. Cl. G03G 9/09

(52) U.S. Cl. CPC G03G 9/091
USPC 430/18; 399/262; 430/108.1; 430/108.23

(57) ABSTRACT

A magenta toner includes a binder resin including an amorphous resin; a magenta pigment comprising a naphthol pigment; and a release agent. The magenta toner has a glass transition temperature of from 19 to 40° C. The naphthol pigment has an X-ray diffraction pattern having plural peaks in the following range:

0°≦2θ≦35°

wherein θ is a Bragg angle.

The sum of half widths of the respective peaks is from 5 to 10°.

### CROSS-REFERENCE TO RELATED APPLICATIONS

This patent application is based on and claims priority pursuant to 35 U.S.C. §119 to Japanese Patent Application No. 2013-050190, filed on Mar. 13, 2013, in the Japan Patent Office, the entire disclosure of which is hereby incorporated by reference herein.

### BACKGROUND

1. Technical Field

The present invention relates to a magenta toner, and a developer for electrophotography, a toner cartridge for electrophotography, an image forming apparatus and a printed matter using the magenta toner.

2. Description of the Related Art

Recently, toners have been required to have smaller particle diameter to produce higher quality images and low-temperature fixability to save energy. Particularly, an electric power consumed from switch-on to production of images (for warm-up time) is preferably as small as possible, and the warm-up time is strongly required to be shortened. However, toners prepared by conventional kneading methods are being technically difficult to have smaller particle diameter. They have various problems. e.g., their forms are amorphous, particle diameter distributions are broad and fixing energies are high. Particularly, the toner prepared by kneading and pulverizing methods cracks at an interface with a release agent, and therefore it is present on the surface of the toner in many cases to efficiently exert a release effect. However, it easily adheres to a carrier, a photoreceptor and a blade.

In order to solve these problems of the toner prepared by kneading and pulverizing methods, polymerization methods of preparing toner are suggested. The polymerization methods are capable of making toner particle diameter smaller and the particle diameter distribution sharper than that of the pulverization toner, and involving a release agent. For example, Japanese published unexamined applications Nos. JP-S63-282752-A and JP-H6-250439-A disclose emulsion polymerization aggregation methods of preparing toner. In addition, Japanese published unexamined applications Nos. JP-2000-275907-A and JP-2001-305797-A disclose methods of improving problems of using a surfactant in the emulsion polymerization aggregation methods.

Japanese published unexamined application No. JP-H11-133665-A discloses a toner having a practical sphericity of from 0.90 to 1.00, including an elongated reactant of urethane-modified polyester as a binder for the purpose of improving fluidity, low-temperature fixability and hot offset resistance. Japanese published unexamined applications Nos. JP-2002-287400-A and JP-2001-351143-A discloses small-particle dry toners having good powder fluidity, transferability, heat-resistant preservability, low-low-temperature fixability and hot offset resistance. These toner preparation methods include a polymerization process subjecting a polyester prepolymer including an isocyanate group to a polyaddition reaction with an amine in an organic solvent and an aqueous medium and a process of removing the organic solvent by heating or the like. Japanese published unexamined application No. JP-2005-77776-A discloses a method of removing the organic solvent in details.

However, since a soap, particles, water-soluble polymers and the like adhere to these conventional polymerization toners prepared in water when prepared, meltability thereof, adherence between the toners and adherence thereof with papers are poor, resulting in poor colorability. Particularly when a toner is used in a low adherence amount, good colorability is needed. On a glossy paper particularly needing high colorability, a magenta toner is poor in colorability in a low adherence amount. When the toner adherence amount is too small, it is difficult to completely cover the background of even glossy papers having comparatively smooth surfaces therewith, and conventional magenta toners are difficult to have good colorability.

Japanese published unexamined application No. JP-2006-267741-A discloses a toner including a naphthol pigment having a specific X-ray diffraction pattern and a quinacridone pigment. A crystalline material having a narrow half width is used, and since the crystallinity is strong and the crystal is hard, it is difficult to disperse in a toner, resulting in insufficient density and hue. Further, the toner is short of extendability and unable to reproduce hue when the toner adherence amount is small.

Because of these reasons, a need exists for a magenta toner having good colorability on a recording medium, particularly on a glossy paper needing high colorability, and good preservability as well.

### SUMMARY

Accordingly, one object of the present invention is to provide a magenta toner having good colorability on a recording medium, particularly on a glossy paper needing high colorability, and good preservability as well.

Another object of the present invention is to provide a developer for electrophotography including the magenta toner.

A further object of the present invention is to provide a toner cartridge for electrophotography filled with the magenta toner.

Another object of the present invention is to provide an image forming apparatus including the toner cartridge.

A further object of the present invention is to provide a printed matter using the magenta toner.

These objects and other objects of the present invention, either individually or collectively, have been satisfied by the discovery of a magenta toner, including a binder resin including an amorphous resin; a magenta pigment comprising a naphthol pigment; and a release agent. The magenta toner has a glass transition temperature of from 19 to 40° C. The naphthol pigment has an X-ray diffraction pattern having plural peaks in the following range:

0°≦2θ≦35°

wherein θ is a Bragg angle.

The sum of half widths of the respective peaks is from 5 to 10°.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIGURE is an example of the X-ray diffraction pattern.

### DETAILED DESCRIPTION

The present invention provides a magenta toner having good colorability on a recording medium, particularly on a glossy paper needing high colorability, and good preservability as well.

The naphthol magenta pigment produces electrophotographic images having high image density and effectively produces desired color gamut, but has poor dispersibility in a toner resin and is too reddish. However, the present inventors found suitable crystallization improves dispersibility and makes hue bluish. The crystallization is assumed by a peak intensity, a width, a diffraction angle and the like of the X-ray diffraction. In the present invention, plural peaks having specific widths and intensities are mixed, i.e., plural peaks are present in a range of 2θ of from 0 to 35°, and the sum of half width of the peak having maximum intensity and half width of a second having not less than ¼ of the peak having maximum intensity is from 5 to 10°. As targeted color in the present invention, it is preferable that L* is from 43 to 49, a* is from 73 to 79 and b* is from −7 to −1 in CIE Lab of an image when formed on a glossy paper at an adherence amount of 0.30 mg/cm² or less with a magenta toner. The half width is a peak width at an intensity which is a half of the peak intensity.

The glossy paper included POD gloss coat having a weight of 158 g/m², a thickness of 75 μm and whiteness not less than 80% from Oji Paper Co., Ltd.

The CIE Lab is measured using X-Rite 938 from X-Rite, Inc. under the following conditions.

Light source: D50

Light measurement: 0° light reception, 45° illumination

Color measurement: 2° eyesight

10 glossy papers are overlapped

Further, In order to produce images having the hue with a toner having an adherence amount of 0.30 mg/cm², in addition to the crystallization of the magenta pigment, the toner needs to include a crystalline resin and have a glass transition temperature of from 19 to 40° C. Sharp meltability of the crystalline resin and an effect of promoting melting of other resins uniformly and lubricously fix a toner on a recording medium and the desired color gamut is obtained even with a small adherence amount.

The magenta toner having an extremely low glass transition temperature and including a crystalline resin has good colorability even with a small adherence amount.

In methods of overlapping plural colors, and developing and transferring them, methods of transferring them once on papers with an intermediate transferer are used to produce high-quality images. The transparency and colorability of the magenta toner are important factors to control color properties of images.

The naphthol pigment used in the present invention includes a compound having the following formula (1):

[chemical structure]

wherein R is one of the following groups:

[chemical structure]

and R′ is a hydrogen atom, an alkyl group or a methoxy group.

This is obtained by a coupling reaction between a diazonium salt and a naphthol compound. Particularly, a compound having the following formula is preferably used.

[chemical structure]

Specific examples thereof include, but are not limited to, known pigments such as Pigment Red 184 and Pigment Red 269.

Preferred compounds are red, bluish, red and carmine compounds disclosed in Table 18 on page 289 in Industrial organic Pigments Second Edition written by W. Herbest and K. Hunger, published by A Wiley company in 1997.

In order to satisfy crystallinity of the naphthol pigment, synthesizing conditions for controlling a primary particle diameter and uniformity of the pigment are important.

Specifically, in the coupling reaction between the diazonium salt and a naphthol compound, the reaction field is controlled to have a pH of from 10 to 12.

An additive may be added to control the particle diameter when necessary. Specific examples of the additives include rosin waxes, waxes, surfactants and particulate colloid metallic oxides having a particle diameter not greater than 100 nm. Other reaction temperatures and refinery conditions are important factors as well.

The toner preferably includes the naphthol pigment in an amount of from 3 to 20 parts by weight. When Pigment Red 269 is used as the naphthol pigment, the toner preferably includes Pigment Red 269 in an amount of from 5 to 15 parts by weight.

A magenta pigment which can be mixed with the naphthol pigment includes quinacridone colorants having the following formula (2):

[chemical structure]

wherein X1 and X2 independently represent a hydrogen atom, a halogen atom, an alkyl group or an alkoxy group.

Particularly, C. I. Pigment Red 122, C. I. Pigment Red 202 or C. I. Pigment Violet 19 (disclosed in color index, 4^{th} edition) is preferably used in terms of physical stability such as hue and light resistance.

Further, the following magenta pigments may be used together.

Colcothar, red lead, lead vermilion, cadmium red, cadmium mercury red, antimony vermilion, permanent red 4R, parared, fiser red, parachloroorthonitro aniline red, lithol fast scarlet G brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red FSR, brilliant carmine 6B, pigment scarlet 3B, Bordeaux 5B, toluidine Maroon, permanent Bordeaux F2K, Helio Bordeaux BL, Bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, etc.

The X-ray diffraction measurement of the naphthol pigment is performed using a sample horizontal type strong X-ray diffractometer RINT TTRII from Rigaku Corp.

A sample is uniformly packed in a hole or a groove of a sample filler using an exclusive sample holder, and is pushed with glass plate such that the surface of the sample holder and the sample surface are flat.

### [X-Ray Diffraction Measurement Conditions]

Bulb: Cu

Parallel beam optical system

Voltage: 50 kV

Current: 300 mA

Start angle: 0°

Finish angle: 35°

Step width: 0.02°

Scan speed: 1.00°/min

Divergence slit: Open

Divergence vertical limit slit: 10 mm

Scattering slit: Open

Light receiving slit: Open

### [Integrated Intensity of Diffraction Peak]

The integrated intensities of various peaks in the X-ray diffraction pattern are determined by measuring the peak area using an analysis software jade 6 from Rigaku Corp. The measurement method is explained using the example of the X-ray diffraction pattern in FIGURE.

Specifically, when a Bragg angle is θ, in a range of from 0 to 35° of 20, a peak separation is made and the following steps (1) to (5) are taken.

(1) All areas under a curve of the separated X-ray diffraction curve are determined.

(2) An area under a straight line from the minimum angle to the maximum angle on the diffraction curve is determined as a background.

(3) In order to separate an amorphous component from the diffraction curve the background is drawn from, a diffraction pattern (hallo pattern) of the amorphous component is designated at a low angle side.

(4) In order to separate the diffraction curves, the crystalline diffraction peaks are designated.

(5) Fittings are performed on the diffraction curves of the amorphous component and the crystalline components designated in (3) and (4), and areas under the curves are determined.

The measurement formulae are as follows.

All integrated intensity (Ia)=all areas in a predetermined range—an area of the background

Integrated intensity of peak (Ib)=(Ia)—an area of amorphous component

Integrated intensity of peak (Ic) of diffraction peak (P2)=an area of (P2) in amorphous component

The magenta toner is formed with a pigment dispersion, which preferably includes a magenta pigment in an amount of from 30 to 70 parts by weight per 100 parts by weight of its solid contents including an amorphous resin. When less than 30 parts by weight, the dispersion is needed much, which is uneconomical. When greater than 70 parts by weight, the pigment dispersibility may worsen.

The magenta toner preferably includes a magenta pigment, but which is not particularly limited to, in an amount of from 2.0 to 10.0 parts by weight, more preferably from 4.0 to 8.0 parts by weight, and furthermore preferably from 5.0 to 7.0 parts by weight.

Since the pigment dispersion wets a pigment with a resin of a masterbatch (pigment dispersion) to assist pigment dispersibility, it preferably includes a release agent in an amount of from 1 to 30 parts by weight per 100 parts by weight solid contents thereof.

The pigment dispersion is obtained by mixing and kneading a resin for masterbatch, a magenta pigment and a release agent while applying a high shearing force thereto. Then, an organic solvent may be used to increase interaction between the magenta pigment and the resin. High shear dispersers such as three-roll mils are preferably used to mix and knead them.

The resins for masterbatch are not particularly limited, e.g., amorphous resins can be used.

### <Amorphous Resins>

Specific examples of the amorphous resins include polymers of styrene or substitution thereof such as polyester, polystyrene, poly-p-chlorostyrene and polyvinyl toluene; styrene copolymers such as styrene-p-chlorostyrene copolymer, styrene-propylene copolymer, styrene-vinyl toluene copolymer, styrene-vinyl naphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl α-chloromethacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, and styrene-maleic acid ester copolymer; and others including polymethyl methacrylate, polybutyl methacrylate, polyvinyl chloride, polyvinyl acetate, polyethylene, polypropylene, polyester, epoxy resin, epoxy polyol resin, polyurethane, polyamide, polyvinyl butyral, polyacrylic acid resin, rosin, modified rosin, a terpene resin, an aliphatic or alicyclic hydrocarbon resin, and an aromatic petroleum resin. These may be used alone or in combination.

The amorphous resin is preferably incompatible with a particulate acrylic resin mentioned later. Therefore, the amorphous resin is preferably a polyester resin. When the particulate acrylic resin is a particulate crosslinked resin including an acrylic ester polymer or a methacrylic ester polymer, it is preferably used because these are almost incompatible with a polyester resin.

When the particulate acrylic resin is added before or after emulsification when preparing a magenta toner, the particulate acrylic resin may melt after adhering to the surface of a droplet of toner materials including an organic solvent. When a polyester resin forms a magenta toner and the particulate acrylic resin is a particulate crosslinked resin including an acrylic ester polymer or a methacrylic ester polymer, the particulate acrylic resin is incompatibly present adhering to a droplet of toner materials because compatibility between the resins is low. Therefore, the amorphous resin penetrates from the surface of the droplet to some extent, and preferably adheres to the surface of a toner and is fixed thereon after the organic solvent is removed.

An unmodified amorphous resin is dissolved in an organic solvent in an amount of 50% by weight, and various solutions are added to the solution. When the solution is visually separated into two layers, the resin is incompatible. When not separated, the resin is compatible.

—Polyester Resin (Amorphous Polyester Resin)—

The polyester resin (amorphous polyester resin) is not particularly limited and may be appropriately selected according to purpose, e.g., it is obtained by polycondensation of alcohol and carboxylic acid.

Specific examples of the alcohols include glycols such as ethylene glycol, diethylene glycol, triethylene glycol and propylene glycol; etherified bisphenols such as 1,4-bis(hydroxymethyl)cyclohexane and bisphenol A; and other diol monomers.

Specific examples of the carboxylic acids include divalent organic acid monomers such as adipic acids, maleic acids, fumaric acids, phthalic acids, isophthalic acids, terephthalic acids, succinic acids and malonic acids.

The amorphous polyester resin preferably includes a crosslinked component. The crosslinked component includes alcohols having three or more valences, carboxylic acids having three or more valences, and the like.

The alcohols having three or more valences include glycerin, and the like.

The carboxylic acids having three or more valences include polycarboxylic acid monomers such as trimellitic acids, 1,2,4-cyclohexanetricarboxylic acids, 1,2,4-naphthalenetricarboxylic acids, 1,2,5-hexanetricarboxylic acids, 1,3-dicarboxyl-2-methylenecarboxy propane and 1,2,7,8-octanetetracarboxylic acids.

The amorphous resin preferably has a glass transition temperature, but which is not particularly limited to, higher than 20° C. and less than 40° C., and more preferably from 29 to 38° C. The resultant toner preferably has a glass transition temperature, but which is not particularly limited to, higher than 20° C. and less than 40° C., and more preferably from 29 to 38° C. as well. When not higher than 20° C., the resultant toner may not have a desired color gamut or deteriorate in heat-resistant preservability and durability against stress such as stirring. When not less than 40° C., the resultant toner may not have a desired color gamut or deteriorate in low-temperature fixability because of having high viscoelasticity when melted. The amorphous resin preferably has a weight-average molecular weight of, but which is not particularly limited to, from 10,000 to 200,000, and more preferably from 15,000 to 150,000. When less than 10,000, hot offset may occur and fixable temperature range may not be widened. When greater than 200,000, the resultant toner may not have low-temperature fixability because the amorphous resin, e.g., a polyester resin has too high a melt viscosity.

The magenta toner preferably includes the amorphous polyester resin, but which is not limited to, in an amount of from 50.0 to 95.0 parts by weight, more preferably from 60.0 to 90.0 parts by weight, and furthermore preferably from 75.0 to 85.0 parts by weight. When less than 50 parts by weight, a pigment and a release agent in a toner deteriorate in dispersibility, resulting in foggy and distorted mages. When greater than 95.0 parts by weight, the resultant toner may deteriorate in low-temperature fixability because of including the crystalline resin less. When the magenta toner includes the amorphous polyester resin from 75.0 to 85.0 parts by weight, the resultant toner excels in colorability, high-quality images, high stability and low-temperature fixability.

The molecular structure of the amorphous resin can be found by X-ray diffraction, GC/MS, LC/MS, IR measurement or the like besides NMR measurement using a solution or a solid. Simply, the amorphous resin does not have an absorption based on 6CH (an outersurface deformation vibration) of olefin at 965±10 cm⁻¹ and 990±10 cm⁻¹ in an infrared absorption spectrum.

Having high crystallinity, the crystalline resin quickly lowers in viscosity around fixation starting temperature. Such a crystalline resin is used in the magenta toner, the heat-resistant preservability is good just before a melt starting temperature and quickly melts thereat. Therefore, the toner has both heat-resistant preservability and low-temperature fixability. In addition, the toner has good release width (a difference between the fixable minimum temperature and the hot offset occurrence temperature).

The binder resin preferably includes the crystalline resin in an amount of from 20 to 80% by weight, and more preferably from 50 to 65% by weight.

Specific examples of the crystalline resin include, but are not limited to any crystalline resins such as a polyester resin, a polyurethane resin, a polyurea resin, a polyamide resin, a polyether resin, a vinyl resin and a modified crystalline resin. These can be used alone or in combination. Among these, since a polyester resin used as an amorphous component in the magenta toner, the crystalline polyester resin is preferably used in terms of compatibility with the amorphous component polyester resin when heated.

—Polyester resin (Crystalline Polyester Resin)—

The crystalline polyester resin is produced using a polyhydric alcohol component and a polycarboxylic acid component such as a polycarboxylic acid, a polycarboxylic anhydride or a polycarboxylic acid ester.

The polyhydric alcohol component is not particularly limited and may be appropriately selected depending on the intended purpose. Examples thereof include diols and trihydric or higher alcohols.

Examples of the diols include saturated aliphatic diols. Examples of the saturated aliphatic diols include linear saturated aliphatic diols and branched saturated aliphatic diols, with linear saturated aliphatic diols being preferred, with C4-C12 linear saturated aliphatic diols being more preferred. When the branched saturated aliphatic diols are used, the formed crystalline polyester resin decreases in crystallinity and thus decreases in melting point in some cases. Also, in a case when the number of carbon atoms contained in the main chain thereof is less than 4, when such diols are polycondensed with an aromatic dicarboxylic acid, the formed crystalline polyester resin may increase in melting temperature to prevent low temperature fixing. Whereas, such diols that have carbon atoms exceeding 12 in the main chain thereof are difficult to obtain practically.

Examples of the saturated aliphatic diols include ethylene glycol, 1,3-propanediol, 1,4-butanediol, 1,5-pentandiol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol and 1,20-eicosanediol. Among them, preferred are 1,4-butanediol, 1,6-hexanediol, 1,8-octanediol, 1,10-decanediol and 1,12-dodecanediol, since the formed crystalline polyester resin has high crystallinity and excellent sharp melt property.

Examples of the trihydric or higher alcohols include glycerin, trimethylolethane, trimethylolpropane and pentaerythritol.

These may be used alone or in combination.

The polycarboxylic acid component is not particularly limited and may be appropriately selected depending on the intended purpose. Examples thereof include divalent carboxylic acids and tri- or higher valent carboxylic acids.

Examples of the divalent carboxylic acids include saturated aliphatic dicarboxylic acids such as oxalic acid, malonic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid and 1,18-octadecanedicarboxylic acid; aromatic dicarboxylic acids such as dibasic acids; e.g., phthalic acid, isophthalic acid, terephthalic acid and naphthalene-2,6-dicarboxylic acid; and anhydrides or lower alkyl esters thereof (such as alkyl esters having 1 to 4 carbon atoms).

Examples of the tri- or higher valent carboxylic acids include 1,2,4-benzenetricarboxylic acid, 1,2,5-benzenetricarboxylic acid and 1,2,4-naphthalenetricarboxylic acid; and anhydrides or lower alkyl esters thereof.

The polycarboxylic acid component may further contain a dicarboxylic acid component having a sulfonic acid group, in addition to the saturated aliphatic dicarboxylic acid and/or the aromatic dicarboxylic acid. Moreover, it may further contain a dicarboxylic acid component having a double bond such as mesaconic acid, in addition to the saturated aliphatic dicarboxylic acid and/or the aromatic dicarboxylic acid.

These may be used alone or in combination.

It is preferred that the crystalline polyester resin have a constituent unit derived from the saturated aliphatic dicarboxylic acid and a constituent unit derived from the saturated aliphatic diol, since it has high crystallinity to be excellent in sharp melt property and hence excellent in low temperature fixability.

The melting point of the crystalline polyester resin is not particularly limited and may be appropriately selected depending on the intended purpose. It is preferably 55° C. or higher but lower than 80° C., more preferably 55° C. or higher but lower than 75° C., and furthermore preferably 57° C. or higher but lower than 70° C. When the melting point thereof is lower than 55° C., the crystalline polyester resin easily melts at low temperatures, potentially degrading the toner in heat resistance storage stability. Whereas when it is 80° C. or higher, the crystalline polyester resin does not sufficiently melt with heating upon fixing of the resin, potentially degrading the toner in low temperature fixability.

The melting point can be measured based on the endothermic peak value in a differential scanning calorimetry (DSC) chart obtained through measurement with a differential scanning calorimeter (DSC).

The molecular weight of the crystalline polyester resin is not particularly limited and may be appropriately selected depending on the intended purpose. The crystalline polyester resin having a sharp molecular weight distribution and a low molecular weight is excellent in low temperature fixability. Also, when there is a large amount of low-molecular-weight components, the crystalline polyester resin is degraded in heat resistance storage stability.

From this viewpoint, through GPC measurement, soluble matter of the crystalline polyester resin in o-dichlorobenzene preferably has a weight average molecular weight (Mw) of 3,000 to 30,000, a number average molecular weight (Mn) of 1,000 to 10,000, and an Mw/Mn of 1.0 to 10.

More preferably, the weight average molecular weight (Mw) thereof is 5,000 to 15,000, the number average molecular weight (Mn) thereof is 2,000 to 10,000, and the Mw/Mn thereof is 1.0 to 5.0.

The amount of the crystalline polyester resin is not particularly limited and may be appropriately selected depending on the intended purpose. It is preferably from 2.0 to 20.0 parts by weight, and more preferably from 5 to 20 parts by weight per 100 parts by weight of the magenta toner. When it is less than 2.0 parts by weight, the crystalline polyester resin cannot sufficiently exhibit its sharp melt property to potentially degrade the toner in low temperature fixability. When it is more than 20 parts by weight, the formed toner may be degraded in heat resistance storage stability and may easily cause image fogging. When the amount of the crystalline polyester resin falls within the above more preferred range, the formed toner advantageously is excellent in all of image quality, stability and low temperature fixability.

The amorphous resin and the crystalline resin are preferably present incompatible with each other before heated and compatible with each other after heated. When compatible before heated, the toner may deteriorate in heat-resistant preservability. When incompatible after heated, the toner may deteriorate in low-temperature fixability.

One material is dissolved in an organic solvent is an amount of 50% by weight to prepare a solution. The other material is dissolved in an organic solvent is an amount of 50% by weight to prepare another solution. The latter solution is added to the former solution. When the mixture is visually separated into two layers, they are determined to be incompatible. When not separated, they are determined to be compatible.

When the crystalline resin is not dissolved in an organic solvent, the cross section of the resultant toner is observed and whether there is a domain of the crystalline resin or not determines compatibility.

### <Release Agent>

The release agent is not particularly limited and may be appropriately selected from known releasing agents.

Examples of waxes usable as the releasing agent include natural waxes such as vegetable waxes (e.g., carnauba wax, cotton wax, Japan wax and rice wax); animal waxes (e.g., bees wax and lanolin); mineral waxes (e.g., ozokelite and ceresine) and petroleum waxes (e.g., paraffin waxes, microcrystalline waxes and petrolatum).

Examples of waxes other than the above natural waxes include synthetic hydrocarbon waxes (e.g., Fischer-Tropsch waxes, polyethylene and polypropylene); and synthetic waxes (e.g., esters, ketones and ethers).

Further examples include low-molecular-weight crystalline polymers such as polyacrylate homopolymers (e.g., poly-n-stearyl methacrylate and poly-n-lauryl methacrylate) and polyacrylate copolymers (e.g., n-stearyl acrylate-ethyl methacrylate copolymers); and crystalline polymers having a long alkyl group in the side chain thereof.

Among them, natural waxes are preferably, vegetable waxes are more preferably, and carnauba wax is furthermore preferably used.

The melting point of the release agent is not particularly limited and may be appropriately selected depending on the intended purpose, but is preferably 50° C. or higher but lower than 90° C.

When the melting point of the releasing agent is lower than 50° C., the releasing agent easily melts at low temperatures and thus the formed toner may be degraded in heat resistant storage stability. Whereas when the melting point of the releasing agent is 90° C. or higher, the releasing agent insufficiently melts with heating upon fixing and thus the toner cannot exhibit satisfactory offset resistance in some cases.

The amount of the release agent is not particularly limited and may be appropriately selected depending on the intended purpose. The amount of the release agent contained in the magenta toner is preferably from 1.0 to 10.0 parts by weight, and more preferably from 3.0 to 7.0 parts by weight. When it is less than 1.0 part by weight, the formed toner may be degraded in low temperature fixability and hot offset resistance upon fixing. Whereas when it is more than 10.0 parts by weight, the formed toner may be degraded in heat resistant storage stability and may cause fogging of images. When the amount of the releasing agent contained in the toner falls within the above more preferred range, the formed toner is advantageously improved in high-quality image formation and fixing stability.

### <Other Component>

The other component is not particularly restricted and may be appropriately selected according to purpose. Examples thereof include a pigment besides the magenta pigment, a charge controlling agent, an inorganic particulate material, a fluidity improver, a cleanability improver, a magnetic material, a metallic soap, and the like.

### <Core Shell Structure>

The magenta toner is preferably formed of a core-shell structure (structure formed of a core and a shell).

For example, on the surface of a mother toner as a core formed of toner materials including an amorphous resin, a crystalline resin, a magenta pigment and a release agent, a particulate acrylic resin adheres as a shell.

### —Core—

The core preferably includes an amorphous resin, a crystalline resin, a magenta pigment and a release agent.

### —Shell—

The shell is not particularly limited and may be appropriately selected according to purpose. A particulate acrylic resin is preferably used.

### —Particulate Acrylic Resin—

The particulate acrylic resin is not particularly limited and may be appropriately selected according to purpose. So as not to be dissolved when adhering to an emulsified droplet and to be fixed on the surface of a mother toner, it is preferably a crosslinked polymer, and more preferably copolymerized with a monomer having two unsaturated groups.

The monomer having two unsaturated groups is not particularly limited and may be appropriately selected according to purpose. Examples thereof include a sodium salt of a sulfate ester with an additive of ethylene oxide methacrylate (ELEMINOL RS-30 from Sanyo Chemical Industries, Ltd.), divinylbenzene, 1,6-hexanediolacrylate, ethyleneglycoldimethacrylate, etc.

The particulate acrylic resin typically does not include styrene.

The particulate acrylic resin preferably has a glass transition temperature of, but is not limited to, from 30 to 115° C., more preferably from 40 to 110° C., and furthermore preferably from 80 to 105° C. When less than 30° C., the resultant toner may deteriorate in preservability and cause blocking when stored and in an image developer. When higher than 115° C., the particulate resin may prevent the toner from adhering to a paper, resulting in increase of fixable minimum temperature.

The glass transition temperature of the particulate acrylic resin can be said to be that of the shell.

The particulate acrylic resin preferably has a volume-average particle diameter of, but is not limited to, from 10 to 500 nm, and more preferably from 10 to 100 nm. When the particulate acrylic resin having the volume-average particle diameter adheres to the surface of the core, a space effect can reduce non-electrostatic adhesion of toner particles. In addition, even in a high-speed machine having large mechanical stress, the particulate acrylic resin is buried in the surface of a toner to prevent the non-electrostatic adhesion from increasing, and sufficient transfer efficiency can be maintained for long periods. This is particularly effective in a first and a second transfer processes in an intermediate transfer method. This is more effective in comparatively a high-speed image forming process having a transfer linear speed of from 300 to 1,000 mm/sec and a transfer time at a second nip of from 0.5 to 20 msec.

When less than 10 nm, the spacer effect is not enough to reduce the non-electrostatic adhesion of toner particles. Further, in a high-speed machine having large mechanical stress, the particulate acrylic resin or external additives are easy to bury in the surface of a toner, and the sufficient transfer efficiency may not be maintained for long periods. When larger than 500 nm, the resultant toner may deteriorate in fluidity to impair uniform transferability.

The volume-average particle diameter can be measured by LA-920 from Horiba, Ltd.

Typically, a toner filled in an image developer, the effect of reducing adhesion is lost because resin particles on the surface of the toner are buried in the toner or concave part on the surface of the mother toner due to mechanical stress in the image developer. Further, the external additive is exposed to the same stress and buried in the toner, and adhesion thereof increases.

However, in a toner having a core-shell structure in which the shell is formed of a particulate acrylic resin, the particulate acrylic resin is comparatively large and difficult to bury in a mother toner. Particularly, the particulate acrylic resin is preferably a particulate crosslinked resin including an acrylic acid eater polymer or a methacrylic acid eater polymer. As such a particulate acrylic resin is crosslinked and comparatively hard, it keeps the spacer effect without deforming on the surface of a toner due to mechanical stress in an image developer. It prevents an external additive from being buried and is more suitable for the adhesion maintenance.

The shell is not particularly limited in molecular weight, but preferably includes a tetrahydrofuran-soluble content in a weight-average molecular weight (Mw) of from 10,000 to 1,000,000 when measured by GPC. When less than 10,000, the shell has higher solubility in an organic solvent such as ethylacetate and it may be difficult to transfer materials forming the shell such as a particulate acrylic resin to the surface of a toner. When greater than 1,000,000, the shell increases in resin viscosity and the resultant toner may deteriorate in low-temperature fixability.

The magenta toner preferably includes the shell in an amount of, but is not limited to, from 0.5 to 5.0 parts by weight, more preferably from 1.0 to 4.5 parts by weight, and furthermore preferably from 3.0 to 4.5 parts by weight. When less than 0.5 parts by weight, the spacer effect is insufficient and the non-electrostatic adhesion of a toner may not be reduced. When greater than 5.0 parts by weight, the resultant toner deteriorates in fluidity and uniform transferability. In addition, materials forming the shell such as a particulate acrylic resin are not fully fixed on a toner and may easily release therefrom to adhere to (contaminate) a carrier and a photoreceptor.

The shell and the amorphous resin, and the shell and the crystalline resin are preferably incompatible with each other. When the shell and the amorphous resin or the crystalline resin are compatible with each other, the shell is unable to be present on the surface of a toner and the resultant toner may deteriorate in heat-resistant preservability.

The magenta toner is preferably obtained by dissolving or dispersing toner materials including an amorphous resin, a crystalline resin, a magenta pigment and a release agent in an organic solvent to prepare a toner materials phase, and emulsifying and dispersing the toner materials phase in an aqueous medium phase including water.

The magenta toner preferably has a volume-average particle diameter of, but is not limited to, from 1 to 6 μM, and more preferably from 2 to 5 μm. When less than 1 μm, the toner tends to scatter in the first and the second transfer. When greater than 6 μm, the toner may not produce high-definition images, e.g., insufficient dot reproducibility and worse granularity of halftone images.

### <<Measurement Methods of Melting Point and Glass Transition Temperature (Tg)>>

In the present invention, a melting point and glass transition temperature (Tg) can be measured, for example, by means of a differential scanning calorimeter (DSC) system (Q-200, manufactured by TA Instruments Japan Inc.).

Specifically, a melting point and glass transition temperature of a sample are measured in the following manners.

Specifically, first, an aluminum sample container charged with about 5.0 mg of a sample is placed on a holder unit, and the holder unit is then set in an electric furnace. Next, the sample is heated (first heating) from 0° C. to 150° C. at the heating rate of 10° C./min in a nitrogen atmosphere. A DSC curve is measured by means of a differential scanning calorimeter (Q-200, manufactured by TA Instruments Japan Inc.).

A melting point and a glass transition temperature of the sample are determined from the obtained DSC curve by means of an analysis program stored in the Q-200 system. An endothermic peak top temperature of the sample is determined as a melting point of the sample.

### <<Measurement Methods of Acid Value>>

The acid value can be measured by the method according to JIS K0070-1992. Specifically, 0.5 g of sample (soluble matter in ethyl acetate: 0.3 g) is added to 120 mL of toluene, and the resultant mixture is stirred for about 10 hours at 23° C. for dissolution. Next, ethanol (30 mL) is added thereto to prepare a sample solution. Notably, when the sample is not dissolved in toluene, another solvent such as dioxane or tetrahydrofuran is used. Then, a potentiometric automatic titrator (DL-53 Titrator, manufactured by Mettler-Toledo K.K.) and an electrode DG113-SC (product of Mettler-Toledo K.K.) are used to measure the acid value at 23° C. The measurements are analyzed with analysis software LabX Light Version 1.00.000. Note that, a mixed solvent of 120 mL of toluene and 30 mL of ethanol is used for calibration of the device.

The measuring conditions are as follows.

[Conditions of Measurement]

| | |
|---|---|
| Stir | |
| Speed [%] 25 | |
| Time [s] 15 | |
| EQP titration | |
| Titrant/Sensor | |
| Titrant CH₃ONa | |
| Concentration [mol/L] 0.1 | |
| Sensor DG115 | |
| Unit of measurement mV | |
| Predispensing to volume | |
| Volume [mL] 1.0 | |
| Wait time [s] 0 | |
| Titrant addition | Dynamic |
| dE (set) [mV] | 8.0 |
| dV (min) [mL] | 0.03 |
| dV (max) [mL] | 0.5 |
| Measure mode | Equilibrium controlled |
| dE [mV] | 0.5 |
| dt [s] | 1.0 |
| t (min) [s] | 2.0 |
| t (max) [s] | 20.0 |
| Recognition | |
| Threshold | 100.0 |
| Steepest jump only | No |
| Range | No |
| Tendency | None |
| Termination | |
| at maximum volume [mL] | 10.0 |
| at potential | No |
| at slope | No |
| after number EQPs | Yes |
| n = 1 | |
| comb. termination conditions | No |
| Evaluation | |
| Procedure | Standard |
| Potential 1 | No |
| Potential 2 | No |
| Stop for reevaluation | No |

The acid value can be measured in the above-described manner. Specifically, the sample solution is titrated with a pre-standardized 0.1N potassium hydroxide/alcohol solution and then the acid value is calculated from the titer using the equation: acid value (KOHmg/g)=titer (mL)×N×56.1 (mg/mL)/mass of sample (g), where N is a factor of 0.1N potassium hydroxide/alcohol solution.

### <<Measurement of Molecular Weight>>

A molecular weight of each constitutional component of a toner can be measured, for example, by the following method.

Gel permeation chromatography (GPC) measuring device: GPC-8220GPC (manufactured by TOSOH CORPORATION)

Column: TSKge1 SuperHZM-H 15 cm, three connected columns (manufactured by TOSOH CORPORATION)

Temperature: 40° C.

Solvent: THF

Flow rate: 0.35 mL/min

Sample: 0.4 mL of a 0.15% by mass sample to be supplied

As for the pretreatment of the sample, the sample is dissolved in tetrahydrofuran (THF) (containing a stabilizer, manufactured by Wako Chemical Industries, Ltd.) to give a concentration of 0.15% by mass, the resulting solution is then filtered through a filter having a pore size of 0.2 μm, and the filtrate from the filtration is used as a sample. The measurement is performed by supplying 100 μL of the tetrahydrofuran (THF) sample solution. For the measurement of the molecular weight of the sample, a molecular weight distribution of the sample is calculated from the relationship between the logarithmic value of the calibration curve prepared from a several monodispersible polystyrene standard samples and the number of counts. As the standard polystyrene samples for preparing the calibration curve, Showdex STANDARD Std. Nos. S-7300, S-210, S-390, S-875, S-1980, S-10.9, S-629, S-3.0, and S-0.580 of SHOWA DENKO K.K., and toluene are used. As the detector, a refractive index (RI) detector is used.

As for the crystalline resin, orthodichlorobenzene instead of THF is used.

### <Method of Preparing Magenta Toner>

Methods of preparing a magenta toner and include, but are not limited to, a method including a process of preparing a toner materials phase, a process of preparing an aqueous medium phase, a process of preparing an emulsion or a dispersion, a process of removing an organic solvent and a process of heating, and other processes when necessary.

### —Process of Preparing Toner Materials Phase—

The a process of preparing a toner materials phase is not particularly limited, provided it is a process of preparing a solution or a dispersion including an organic solvent, and toner materials including an amorphous resin or its precursor, a crystalline resin, a magenta pigment and a release agent dissolved and dispersed therein.

The amorphous resin precursor is not particularly limited, provided it is a precursor which becomes an amorphous resin in a toner. Examples thereof include a compound including an active hydrogen group and a polymer (prepolymer) reactable therewith. When the toner materials include the compound including an active hydrogen group and the polymer (prepolymer) reactable therewith, the resultant toner increases in mechanical strength and burial of the particulate acrylic resin and external additives can be prevented. When the compound including an active hydrogen group has a cationic polarity, it can electrostatically draw the particulate acrylic resin. Further, fluidity of a toner when fixed with heat can be controlled to widen a fixable temperature width thereof.

The compound including an active hydrogen group includes, but is not limited to, an amine compound. The amine compound includes, but is not limited to, a ketimine compound.

The polymer (prepolymer) reactable with the compound including an active hydrogen group includes, but is not limited to, a polyester resin including an isocyanate group.

The organic solvent is not particularly restricted and may be appropriately selected according to purpose, and those having a boiling point of less than 150° C. are preferable in view of easy removal.

The organic solvents having a boiling point of less than 150° C. are not particularly restricted and may be appropriately selected according to purpose. Examples thereof include toluene, xylene, benzene, carbon tetrachloride, methylene chloride, 1,2-dichloroethane, 1,1,2-trichloroethane, trichlorethylene, chloroform, monochlorobenzene, dichloroethylidene, methyl acetate, ethyl acetate, methyl ethyl ketone, and methyl isobutyl ketone.

Among these, ethyl acetate, toluene, xylene, benzene, methylene chloride, 1,2-dichloroethane, chloroform, and carbon tetrachloride are preferable, and ethyl acetate is more preferable.

These may be used alone or in combination of two or more.

The toner materials preferably includes the organic solvent in an amount of, but is not limited to, from 40 to 300 parts by weight, more preferably from 60 to 140 parts by weight, and more preferably from 80 to 120 parts by weight.

The components in the toner materials besides the amorphous resin precursor may be added to an aqueous medium in a process of preparing an aqueous medium phase mentioned later or together with the solution or the dispersion of the toner materials when mixed with the aqueous medium.

### —Process of Preparing Aqueous Medium—

The process of preparing an aqueous medium phase is not particularly limited, provided it is a process of preparing an aqueous medium phase including a particulate styrene/acrylic resin and a particulate acrylic resin.

The aqueous medium is not particularly restricted and may be appropriately selected according to purpose. Examples thereof include water, a solvent miscible with water, and a mixture thereof. These may be used alone or in combination of two or more. Among these, water is preferable.

The solvent miscible with water is not particularly restricted and may be appropriately selected according to purpose.

Examples thereof include alcohols, dimethylformamide, tetrahydrofuran, cellosolves, and lower ketones.

The alcohols are not particularly restricted and may be appropriately selected according to purpose. Examples thereof include methanol, isopropanol, and ethylene glycol.

The lower ketones are not particularly restricted and may be appropriately selected according to purpose. Examples thereof include acetone, and methyl ethyl ketone.

These may be used alone or in combination of two or more.

The aqueous medium phase is prepared by dispersing the particulate styrene/acrylic resin in an aqueous medium under the presence of an anionic surfactant.

The aqueous medium preferably includes the anionic surfactant and the particulate styrene/acrylic resin in an amount of, but are not limited to, from 0.5 to 10% by weight, respectively.

The particulate acrylic resin is then added to the aqueous medium. When the particulate acrylic resin has aggregability with the anionic surfactant, the aqueous medium is preferably dispersed by a high-speed shear disperser before emulsified.

Specific examples of the anionic surfactants include, but are not limited to, fatty acid salt, alkylsulfuric acid ester salt, alkylarylsulfonic acid, alkyl diaryl ether disulfonate, dialkyl sulfosuccinate, alkyl phosphate, naphthalene sulfonic acid formalin condensate, polyoxyethylene alkylphosphonate ester salt and glyceryl borate fatty acid ester.

The particulate styrene/acrylic resin is different from the particulate acrylic resin, and not particularly limited, provided it includes styrene. The particulate styrene/acrylic resin preferably has a volume-average particle diameter of from 5 to 50 nm which is smaller than that of the particulate acrylic resin.

The particulate acrylic resin preferably forms an aggregate in an aqueous medium including the anionic surfactant. In the method of preparing a magenta toner, it is not preferable that the particulate acrylic resin is independently present without adhering to a droplet of toner materials when added to the aqueous medium. The particulate acrylic resin forming an aggregate in an aqueous medium including the anionic surfactant transfers to the surface of a droplet of toner materials and easily adheres thereon when or after emulsified or dispersed. Namely, the particulate acrylic resin is typically unstable and aggregates in the aqueous medium including the anionic surfactant. However, when the droplet of toner materials has large attractive force, a complex of different particles is formed.

### —Process of Preparing Emulsion or Dispersion—

The process of preparing an emulsion or a dispersion is not particularly limited, provided the solution or the dispersion of toner materials (toner materials phase) and the aqueous medium phase are emulsified or dispersed to prepare an emulsion or a dispersion.

Methods of emulsifying or dispersing are not particularly limited, and known dispersers such as low-speed shear dispersers and high-speed shear dispersers can be used. In the emulsification or the dispersion, the compound including an active hydrogen group and the polymer (prepolymer) reactable therewith are elongated or crosslinked to form an adhesive base material. The particulate acrylic resin may be added to the aqueous medium during or after the emulsification. Whether the high-speed shear disperser is used during the emulsification or the low-speed shear disperser is used after the emulsification may be determined while seeing how the particulate acrylic resin adheres to a toner and is fixed thereon.

### —Process of Removing Organic Solvent—

The process of removing an organic solvent is not particularly limited, provided an organic solvent is removed from the emulsion or the dispersion to obtain a desolvated slurry. The organic solvent is removed by (1) a method of gradually heating the emulsion or the dispersion to completely remove an organic solvent in an oil drop thereof by evaporation, (2) a method of spraying the emulsion or the dispersion in a dry atmosphere to completely remove an organic solvent in an oil drop thereof, and the like. The organic solvent is removed to form toner particles.

### —Process of Heating—

The process of heating is not particularly limited, provided the desolvated slurry is heated. For example, the process of heating includes (1) a method of heating in a stationary state, (2) a method of heating while stirring, and the like. The hating process forms toner particles having a smooth surface. When toner particles are dispersed in ion-exchanged water, the heating process may be made before or after washed.

The heating temperature is not limited, but preferably higher than glass transition temperatures of various resins used for preparing a toner.

The heating process firmly fixes the particulate acrylic resin on the surface of a toner.

### —Other Processes—

The other processes include a washing process, a drying process, etc.

### —Washing Process—

The washing process is not particularly limited, provided the desolvated slurry is washed with water after the process of removing an organic solvent and before the process of heating. The water includes ion-exchanged water or the like.

### —Drying Process—

The drying process is not particularly limited, provided the toner particles after the heating process is dried.

In preparation of the magenta toner, the amorphous resin is preferably a polyester resin, which is incompatible with the particulate acrylic resin. In the process of preparing an emulsion or a dispersion, when the particulate acrylic resin is added before or after the emulsification or the dispersion, the particulate acrylic resin may be dissolved after adhering to the surface of a droplet of toner materials because an organic solvent is present therein. When a polyester resin forms a toner and the particulate acrylic resin is a particulate crosslinked resin including an acrylic acid ester polymer or a methacrylic acid ester polymer, the particulate acrylic resin is present adhering to the droplet of toner materials without being compatible because the resins are not compatible with each other. Therefore, the particulate acrylic resin penetrates from the surface of the droplet to some extent, and preferably adheres to the surface of a toner and is fixed thereon after the organic solvent is removed.

The magenta toner is formed of toner particles including the amorphous resin, the crystalline resin and the magenta pigment as main components, the particulate acrylic resin adhering thereon, and further the particulate styrene/acrylic resin adhering thereon. However, the styrene/acrylic resin is buried in the toner particles or between the toner particles and the particulate acrylic resin. Therefore, the toner seems to have the particulate acrylic resin adhering on its surface. The volume-average particle diameter of the toner is controlled by the emulsification and dispersion conditions such as stirring of the aqueous medium in the process of preparing an emulsion or a dispersion. The acid values preferably satisfy the following relationship.

particulate styrene/acrylic resin >amorphous resin and crystalline resin >particulate acrylic resin

The anionic particulate styrene/acrylic resin is fusion-bonded to the surface of a toner to make the surface hard. Therefore, it prevents the fixed particulate acrylic resin from being buried and transferred due to mechanical stress. The anionic particulate styrene/acrylic resin is adsorbed to the droplet including toner materials and prevents the droplets form being combined with each other, which is important to control a particle diameter distribution of the toner. Further, it can negatively charge the toner. In order to exert these effects, the anionic particulate styrene/acrylic resin preferably has a volume-average particle diameter of from 5 to 50 nm which is smaller than the particulate acrylic resin.

The magenta toner of the present invention may be mixed with a carrier to form a two-component developer. Known carriers can be used.

A toner cartridge may be filled with the magenta toner of the present invention, and the toner cartridge may be installed in an image forming apparatus. Known cartridges and image forming apparatuses can be used.

### EXAMPLES

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### <Synthesis of Naphthol Pigment>

(1) Preparation of Pigment Composition including Pigment Red 184

Eighty-four (84) parts of 3-amino-4-methoxybenzanilide were dispersed in 1,500 parts of water, ice was added to the resultant dispersion to have a temperature not higher than 0° C., and 125 parts of a hydrochloric acid aqueous solution having a concentration of 35% were added thereto and stirred for 1 hr to be chlorinated.

Next, after 61.5 parts of sodium nitrite aqueous solution having a concentration of 40% were added to the chlorinated dispersion and stirred for 1 hr, 4 parts of sulphamic acid were added thereto to resolve the excessive nitrous acid to form a diazonium aqueous solution. On the other hand, 58.2 parts (dry pure content conversion) of a wet cake of N-(2′-methyl-5′-chlorophenyl)-3-hydroxy-2-naphthalenecarboxyamidealkaline compound as a coupling component-1 and 66.4 parts (dry pure content conversion) of a wet cake of N-(2′,5′-dimethoxy-4′-chlorophenyl)-3-hydroxy-2-naphthalenecarboxyamidealkaline compound as a coupling component-2 were added in 1,000 parts of water to be dispersed. One part of sodium dodecyl sulfonate was added to the resultant dispersion and water was further added thereto to have a temperature of 20° C. to form a coupler solution.

While the solution maintained a temperature of 20° C., the diazonium aqueous solution was gradually dropped therein to perform a coupling reaction while maintaining pH at 9.5±0.5, and further stirred for 1 hr to complete the reaction.

One hour later, disappearance of the diazonium was seen by a high-speed liquid chromatography, and a proper amount of a hydrochloric acid having a concentration of 35% was added to the solution to have a pH of from 7.0 to 7.5 to obtain a slurry. The slurry was heated and stirred at 60° C. for 1 hr, filtered, washed with water, dried at from 90 to 100° C., and pulverized to obtain a pigment composition A1 including a naphthol pigment: Pigment Red 184.

Further, the synthesis conditions of the pigment composition A1 were variably changed as shown in the following Table 1 to obtain pigment compositions A2 to A5.

The content of the sodium dodecyl sulfonate, pH of the coupling reaction liquid, heating conditions and half width of X-ray diffraction of each of the pigment compositions A 1 to A5 are shown in Tables 1 and 2.

TABLE 1

| | | Sodium | | Coupling | | | Half |
|---|---|---|---|---|---|---|---|
| Pigment | | Dodecyl | | Reaction | Heating | | Width |
| Composition | Pigment | Sulfonate | | Liquid | Conditions | | Total |
| A1 | Pigment A1 | 1 | part | 9.5 ± 0.5 | 60° C. | 1 hr | 11.5 |
| A2 | Pigment A2 | 5 | parts | 10 ± 0.5 | 80° C. | 1 hr | 9.3 |
| A3 | Pigment A3 | 10 | parts | 11 ± 0.5 | 100° C. | 1 hr | 7.2 |
| A4 | Pigment A4 | 10 | parts | 11 ± 0.5 | 110° C. | 3 hrs | 5.1 |
| AS | Pigment A5 | 15 | parts | 12 ± 0.5 | 120° C. | 3 hrs | 4.5 |

TABLE 2

| | | Half Width | | | | |
|---|---|---|---|---|---|---|
| | | Pigment | Pigment | Pigment | Pigment | Pigment |
| Peak No. | 2θ | A1 | A2 | A3 | A4 | A5 |
| Peak 1 | 5.3 | 2.3 | 1.9 | 1.4 | 1.0 | 0.9 |
| Peak 2 | 13.1 | 1.9 | 1.6 | 1.2 | 0.9 | 0.8 |
| Peak 3 | 17.9 | 1.7 | 1.4 | 1.1 | 0.8 | 0.7 |
| Peak 4 | 20.5 | 3.3 | 2.6 | 2.0 | 1.4 | 1.3 |
| Peak 5 | 26.8 | 2.3 | 1.9 | 1.4 | 1.0 | 0.9 |
| Total | | 11.5 | 9.3 | 7.2 | 5.1 | 4.5 |

(2) Preparation of Pigment Composition including Pigment Red 269

The procedure for preparation of the Pigment Red 184 was repeated except for replacing the coupling components with 124.5 parts (dry pure content conversion) of a wet cake of N-(2′-methoxy-5′-chlorophenyl)-3-hydroxy-2-naphthalenecarboxyamidealkaline compound as a coupling component-3 to obtain a pigment composition B1 including a naphthol pigment: Pigment Red 269.

Further, the synthesis conditions of the pigment composition B1 were variably changed as shown in the following Table 1 to obtain pigment compositions B2 to B5.

The content of the sodium dodecyl sulfonate, pH of the coupling reaction liquid, heating conditions and half width of X-ray diffraction of each of the pigment compositions B1 to B5 are shown in Tables 3 and 4.

TABLE 3

| | | Sodium | | Coupling | | | Half |
|---|---|---|---|---|---|---|---|
| Pigment | | Dodecyl | | Reaction | Heating | | Width |
| Composition | Pigment | Sulfonate | | Liquid | Conditions | | Total |
| B1 | Pigment B1 | 1 | part | 9.5 ± 0.5 | 60° C. | 1 hr | 10.4 |
| B2 | Pigment B2 | 5 | parts | 10 ± 0.5 | 80° C. | 1 hr | 9.6 |
| B3 | Pigment B3 | 10 | parts | 11 ± 0.5 | 100° C. | 1 hr | 7.0 |
| B4 | Pigment B4 | 10 | parts | 11 ± 0.5 | 110° C. | 3 hrs | 5.3 |
| B5 | Pigment B5 | 15 | parts | 12 ± 0.5 | 120° C. | 3 hrs | 4.7 |

TABLE 4

| | | Half Width | | | | |
|---|---|---|---|---|---|---|
| Peak | | Pigment | Pigment | Pigment | Pigment | Pigment |
| No. | 2θ | B1 | B2 | B3 | B4 | B5 |
| Peak 1 | 5.5 | 1.4 | 1.3 | 0.9 | 0.7 | 0.6 |
| Peak 2 | 12.8 | 1.5 | 1.4 | 1.0 | 0.8 | 0.7 |
| Peak 3 | 17.9 | 2.0 | 1.9 | 1.4 | 1.0 | 0.9 |
| Peak 4 | 20.3 | 3.2 | 3.0 | 2.2 | 1.7 | 1.5 |
| Peak 5 | 23 | 0.5 | 0.5 | 0.3 | 0.3 | 0.2 |
| Peak 6 | 27 | 1.7 | 1.6 | 1.1 | 0.9 | 0.8 |
| Total | | 10.4 | 9.6 | 7.0 | 5.3 | 4.7 |

### <Synthesis of Amorphous Resin A1>

A reaction tank equipped with a stirrer and a nitrogen-introducing pipe was charged with bisphenol A ethylene oxide 2 mole adduct (66 parts), propylene glycol (2 parts), isophthalic acid (1 part) and an adipic acid (29 parts). The reaction mixture was allowed to react under an increased pressure at 230° C. for 5 hours and further react under a reduced pressure of 10 mmHg to 15 mmHg for 5 hours. Then, a trimellitic acid (2.4 parts) was added to the reaction container, followed by reaction at 240° C. for 1 hour, and the acid value of polyester was adjusted to obtain an amorphous resin A1. The amorphous resin A1 was found to have a number-average molecular weight (Mn) of 5,400, a weight-average molecular weight (Mw) of 16,200 and a glass transition temperature (Tg) of 17.

### <Synthesis of Amorphous Resins A2 to A5>

The procedure for preparation of the amorphous resin A1 was repeated except for changing the amount of the monomer as shown in Table 5 to adjust the glass transition temperature to prepare amorphous resins A2 to A5.

The number-average molecular weight (Mn), the weight-average molecular weight (Mw) and the glass transition temperature (Tg) of each of A1 to A5 are shown in Table 5. The contents of the materials are shown in parts.

TABLE 5

| Amorphous resin | A1 | A2 | A3 | A4 | A5 |
|---|---|---|---|---|---|
| Bisphenol A ethylene | 66 | 66 | 66 | 66 | 66 |
| oxide 2 mole adduct | | | | | |
| Propylene Glycol | 2 | 2 | 2 | 2 | 2 |
| Isophthalic Acid | 1 | 2 | 7 | 10 | 13 |
| Adipic acid | 29 | 28 | 23 | 20 | 17 |
| Trimellitic acid | 2.4 | 2.4 | 2.4 | 2.4 | 3.5 |
| Number-average | 5,400 | 5,300 | 5,000 | 5,200 | 5,500 |
| molecular weight (Mn) | | | | | |
| Weight-average | 16,200 | 16,100 | 16,500 | 17,000 | 15,900 |
| molecular weight (Mw) | | | | | |
| Glass transition | 17 | 19 | 29 | 38 | 43 |
| temperature (Tg) (° C.) | | | | | |

### <Preparation of Masterbatch MBA1>

Water (500 parts), the pigment composition A1 (400 parts) and the amorphous resin A3 (600 parts) and carnauba wax WA-05 from TOA KASEI CO., LTD. (12 parts) were mixed together with HENSCHEL MIXER (product of Mitsui Mining Co.). The resultant mixture was kneaded at 150° C. for 30 min with a two-roller mill, and then rolled, cooled and pulverized with a pulverizer from Hosokawa Micron, Ltd. to obtain masterbatch MBA 1.

### <Preparation of Masterbatches MBA2 to MBAS and MBB1 to MBB5>

The procedure for preparation of the masterbatch MBA1 was repeated except for replacing the pigment composition A1 with the pigment compositions A2 to A5 and B1 to B5 to prepare masterbatches MBA2 to MBAS and MBB 1 to MBB5.

### <Synthesis of Crystalline Resin B1>

A four-neck flask equipped with a nitrogen-introducing pipe, a drainpipe, a stirrer and a thermocouple was charged with 1,10-decanedicarboxylic acid (28 parts), 1,8-octanediol (21 parts), 1,4-butanediol (51 parts) and hydroquinone (0.1 parts), followed by reaction at 180° C. for 10 hours. Thereafter, the reaction mixture was allowed to react at 200° C. for 3 hours and further react at 8.3 kPa for 2 hours, to thereby produce crystalline resin B1. Through GPC measurement of o-dichlorobenzene soluble matter of the crystalline resin B 1, the Mw was found to be 15,000, the Mn was found to be 5,000, the Mw/Mn was found to be 3.0, and the melting point was found to be 67° C.

### <Preparation of Particulate Styrene/Acrylic Resin>

A reactor to which a stirring rod and a thermometer was set was charged with 683 parts of water, 16 parts of a sodium salt of sulfate of methacrylic acid ethylene oxide adduct (ELEMINOL RS-30, manufactured by Sanyo Chemical Industries, Ltd.), 83 parts of styrene, 83 parts of methacrylic acid, 110 parts of acrylic-acid-n-butyl and 1 part of ammonium persulfate, which was stirred at 400 rpm for 15 minutes, and a white emulsion was obtained. This was heated until a temperature in the system reached 75° C. and reacted for 5 hours. Further, it was added with 30 parts of a 1-% ammonium persulfate aqueous solution and aged at 75° C. for 5 hours, and an aqueous dispersion of a vinyl resin (a copolymer of styrene—methacrylic acid—sodium salt of sulfate of methacrylic acid ethylene oxide adduct) [particulate styrene/acrylic resin dispersion] was obtained. The [particulate styrene/acrylic resin dispersion] had volume-average particle diameter of 14 nm when measured by LA-920 (manufactured by Horiba Ltd.), an acid value of 45 mg KOH/g, an Mw of 300,000 and a Tg of 60° C.

### <Preparation of Particulate Acrylic Resin Dispersion for Shell C1>

A reactor to which a stirring rod and a thermometer was set was charged with 683 parts of water, 10 parts of chlorinated distearyl dimethyl ammonium (Cation DS from Kao Corp.), 176 parts of methylmethacrylate, 18 parts of acrylic-acid-n-butyl, 1 part of ammonium persulfate and 2 parts of ethylene glycol dimethacrylate, which was stirred at 400 rpm for 15 minutes, and a white emulsion was obtained. This was heated until a temperature in the system reached 65° C. and reacted for 10 hours. Further, it was added with 30 parts of a 1-% ammonium persulfate aqueous solution and aged at 75° C. for 5 hours, and an aqueous dispersion [particulate acrylic resin dispersion C1] of a vinyl resin (particulate acrylic resin C1) was obtained. The [particulate acrylic resin dispersion C1] had volume-average particle diameter of 35 nm when measured by LA-920 (manufactured by Horiba Ltd.), an acid value of 2 mg KOH/g, an Mw of 30,000 and a Tg of 82° C.

### <Preparation of Particulate Acrylic Resin Dispersions for Shell C2 to C5>

The procedure for preparation of the particulate acrylic resin dispersion C1 was repeated except for changing the contents of the monomers as shown in Table 6 to prepare particulate acrylic resin dispersions C2 to C5. The volume-average particle diameter, acid value Mw and Tg of each thereof are shown in Table 6. The contents of the materials are shown in parts.

TABLE 6

| Particulate acrylic resin | | | | | |
|---|---|---|---|---|---|
| dispersion for shell | C1 | C2 | C3 | C4 | C5 |
| Water | 683 | 683 | 683 | 683 | 683 |
| Chlorinated distearyl | 10 | 10 | 10 | 10 | 10 |
| dimethyl ammonium | | | | | |
| Methylmethacrylate | 176 | 128 | 194 | 128 | 194 |
| Acrylic-acid-n-butyl | 18 | 66 | 0 | 66 | 0 |
| Ammonium persulfate | 1 | 1 | 1 | 1 | 1 |
| Ethylene glycol | 2 | 2 | 2 | 0 | 0 |
| dimethacrylate | | | | | |
| 1-% ammonium persulfate | 30 | 30 | 30 | 30 | 30 |
| aqueous solution | | | | | |
| Volume-average particle | 35 | 55 | 28 | 53 | 33 |
| diameter (nm) | | | | | |
| Acid value | 2 | 3 | 3 | 3 | 5 |
| Weight-average molecular | 30,000 | 25,000 | 38,000 | 12,000 | 18,000 |
| weight (Mw) | | | | | |
| Glass transition | 82 | 43 | 110 | 37 | 103 |
| temperature Tg (° C.) | | | | | |

### Comparative Example 1

### Preparation of Toner

### <Preparation of Release Agent Dispersion Liquid D1>

A vessel to which a stirring bar and a thermometer had been set was charged with 300 parts of the amorphous resin A3 and 100 parts of paraffin wax (HNP-9, manufactured by Nippon Seiro Co., Ltd., hydrocarbon wax, melting point: 75° C.) and 600 parts of ethyl acetate, followed by heating to 80° C. with mixing. The temperature was maintained at 80° C. for 5 hours, followed by cooling to 30° C. over 1 hr to obtain a release agent dispersion liquid D1.

### —Preparation of Aqueous Phase—

Water (660 parts), 10 parts of particulate styrene/acrylic resin dispersion, 25 parts of a 48.5% aqueous solution of sodium dodecyl diphenyl ether disulfonate (ELEMINOL MON-7, manufactured by Sanyo Chemical Industries Ltd.) and 60 parts of ethyl acetate were mixed and stirred, to thereby obtain a milky-white aqueous (medium) phase.

### —Preparation Toner Materials Oil Phase—

In a beaker, 114 parts of ethylacetate and 100 parts of the amorphous resin A3 were dissolved while stirred to form a solution. Next, 100 parts of the release agent dispersion liquid D1, 25 parts of the masterbatch MBA1 and 20 parts of the crystalline resin B1 were placed therein and dispersed by means of a bead mill (ULTRA VISCOMILL, manufactured by AIMEX CO., LTD.), under the following conditions: a liquid feed rate of 1 kg/hr, disc circumferential velocity of 6 m/s, 0.5 mm-zirconia beads packed to 80% by volume, and 3 passes to prepare a material solution (toner material oil phase). In another vessel to which a stirring bar and a thermometer had been set, 90 parts of the aqueous phase and 10 parts of ethylacetate were mixed and stirred at 25° C. to prepare an aqueous phase solution. Fifty (50) parts of the oil phase maintained to have a temperature of 25° C. was added thereto, and the resulting mixture was mixed by means of a TK homomixer at 13,000 rpm and 25° C. for 1 min to thereby obtain an emulsified slurry.

### —Removal of Organic Solvent—

The emulsified slurry was placed in a flask to which a dehydration tube, a stirrer and a thermometer was set and was subjected to desolvation at 30° C. for 12 hours while stirred at circumferential velocity of 20 m/min under reduced pressure to obtain desolvated slurry.

### —Washing—

After all of the desolvated slurry was filtered under reduced pressure, 300 parts of ion-exchanged water were added to the resultant filtered cake and re-dispersed by means of a TK homomixer at 12,000 rpm for 10 min, and then filtered. This was further repeated 3 times until the re-dispersed slurry had a conductivity of from 0.1 to 10 μs/cm to obtain a washed slurry.

### —Heating Treatment—

The washed slurry was placed in a flask to which a stirrer and a thermometer was set and was heated at 50° C. for 60 min while stirred at circumferential velocity of 20 m/min, and then filtered to obtain a filtered cake.

### —Drying—

The filtered cake was dried in a wind dryer at 45° C. for 48 hours and then sieved with a mesh having openings of 75 μm, and mother toner particles were obtained.

### —Application of External Additive—

To 100 parts of the mother toner particles, 0.6 parts of hydrophobic silica having an average particle diameter of 100 nm, 1.0 part of titanium oxide having an average particle diameter of 20 nm and 0.8 parts of hydrophobic silica fine powder having an average particle diameter of 15 nm were mixed using a HENSCHEL mixer to prepare a toner.

### Examples 1 to 6 and Comparative Examples 2 to 4

The procedure for preparation of the toner in Comparative Example 1 was repeated except for replacing the masterbatch MBA1 with the following masterbatches to obtain toners of Examples 1 to 6 and Comparative Examples 2 to 4.

| | |
|---|---|
| Example 1 | MBA2 |
| Example 2 | MBA3 |
| Example 3 | MBA4 |
| Comparative Example 2 | MBA5 |
| Comparative Example 3 | MBB1 |
| Example 4 | MBB2 |
| Example 5 | MBB3 |
| Example 6 | MBB4 |
| Comparative Example 4 | MBB5 |

### Examples 7 and 8 and Comparative Examples 5 and 6

The procedure for preparation of the toner in Comparative Example 1 was repeated except for replacing the amorphous resin A1 with the following amorphous resins to obtain toners of Examples 7 and 8 and Comparative Examples 5 and 6.

| | |
|---|---|
| Comparative Example 5 | Amorphous resin A1 |
| Example 7 | Amorphous resin A2 |
| Example 8 | Amorphous resin A4 |
| Comparative Example 6 | Amorphous resin A5 |

### Example 9

### Preparation Toner Materials Oil Phase

In a beaker, 114 parts of ethylacetate, 90 parts of the amorphous resin A3 and 10 parts of the crystalline resin B1 were dissolved while stirred to form a solution. Next, 100 parts of the release agent dispersion liquid D1, 25 parts of the masterbatch MBA1 and 20 parts of the crystalline resin B1 were placed therein and dispersed by means of a bead mill (ULTRA VISCOMILL, manufactured by AIMEX CO., LTD, under the following conditions: a liquid feed rate of 1 kg/hr, disc circumferential velocity of 6 m/s, 0.5 mm-zirconia beads packed to 80% by volume, and 3 passes to prepare a material solution (toner material oil phase).

The procedure for preparation of the toner in Comparative Example 1 was repeated except for the above operation to obtain a toner of Example 9.

### Example 10

### Preparation of Aqueous Phase

Water (640 parts), 10 parts of particulate styrene/acrylic resin dispersion, 20 parts of the particulate acrylic resin dispersion for shell C3 and 25 parts of a 48.5% aqueous solution of sodium dodecyl diphenyl ether disulfonate (ELEMINOL MON-7, manufactured by Sanyo Chemical Industries Ltd.) and 60 parts of ethyl acetate were mixed and stirred, to thereby obtain a milky-white aqueous (medium) phase.

The procedure for preparation of the toner in Example 9 was repeated except for the above operation to obtain a toner of Example 10.

### Example 11

The procedure for preparation of the toner in Example 10 was repeated except for replacing the particulate acrylic resin dispersion for shell C3 with the particulate acrylic resin dispersion for shell C5 to obtain a toner of Example 11.

### Example 12

The procedure for preparation of the toner in Example 10 was repeated except for replacing the particulate acrylic resin dispersion for shell C3 with the particulate acrylic resin dispersion for shell C1 to obtain a toner of Example 12.

### Example 13

The procedure for preparation of the toner in Example 10 was repeated except for replacing the particulate acrylic resin dispersion for shell C3 with the particulate acrylic resin dispersion for shell C2 to obtain a toner of Example 13.

### Example 14

The procedure for preparation of the toner in Example 10 was repeated except for replacing the particulate acrylic resin dispersion for shell C3 with the particulate acrylic resin dispersion for shell C4 to obtain a toner of Example 14.

### Example 15

### Preparation of Masterbatch MBC1

Water (500 parts), the pigment composition B3 (320 parts), dimethyl quinacridone from Clariant (80 parts) and the amorphous resin A3 (600 parts) and carnauba wax WA-05 from TOA KASEI CO., LTD. (12 parts) were mixed together with HENSCHEL MIXER (product of Mitsui Mining Co.). The resultant mixture was kneaded at 150° C. for 30 min with a two-roller mill, and then rolled, cooled and pulverized with a pulverizer from Hosokawa Micron, Ltd. to obtain masterbatch MBC1.

The procedure for preparation of the toner in Example 9 was repeated except for replacing the MBA1 with the MBC1 to prepare a toner of Example 15.

### Examples 16 to 19

The procedure for preparation of the toner in Example 5 was repeated except for changing the amount of the MBB3 as shown in Tables 8-1 and 8-2 to prepare toners of Examples 16 to 19.

### Examples 20 to 22

The procedure for preparation of the toner in Example 2 was repeated except for changing the amount of the amorphous resin A3 and the crystalline resin B1 as shown in Tables 9-1 and 9-2 to prepare toners of Examples 20 to 22.

The glass transition temperatures (Tg) of the Examples and Comparative Examples were measured by the above-mentioned method. In addition, properties thereof were measured as follows. The results are shown in Tables 7 to 9-2.

### <<Production of Magenta Image>>

On the whole surface of an A4 size glossy paper, a magenta single-colored toner was transferred at 0.3 mg/cm² using a full-color multifunctional printer Imagio NeoC600Pro from Ricoh Company, Ltd. while the image density was controlled. The colors on 9 positions of the image, i.e., the left, the center and the right of each of the top, the middle and the bottom of the image were evaluated and averaged. Producing an unfixed image and blowing the toner with compressed air to remove, and the weight change was determined as the toner adherence amount. The following glossy paper was used.

(Glossy Paper)

POD Gloss Coat from Oji Paper Co., Ltd.

Weight: 158 g/m²

Thickness: 175 μm

Whiteness: 80% or more

Size: A4

### <Color Evaluation>

The color was evaluated using X-Rite 938 from X-Rite, Inc. L*, a* and b* were measured under the following conditions.

Light source: D50

Light measurement: 0° light reception, 45° illumination

Color measurement: 2° eyesight

10 glossy papers are overlapped

### <Preservation>

Twenty (20) g of the toner were sealed in a vial bottle and stored therein at 50° C. for 8 hrs. Then, the toner was sieved by a 42-mesh shifter for 2 min to measure a residual ratio of the toner remaining on the mesh to evaluate by the following 5 grades. The higher the heat-resistant preservability, the smaller the residual ratio of the toner.

5: The residual ratio is less than 10%

4: The residual ratio is not less than 10% and less than 20%

3: The residual ratio is not less than 20% and less than 30% (Minimum level of practical use)

2: The residual ratio is not less than 30% (Practical use is impossible)

1: The toner is solidified and unable to be taken out

### <Fixable Minimum>

Magenta single-colored solid images were produced using a full-color multifunctional printer Imagio NeoC600Pro from Ricoh Company, Ltd. while the surface temperature of the fixing roller was changed from 100 to 200° C. The toner on the image was transferred onto a tape and the contamination of the tape was evaluated in comparison with 5-grade samples. Practically usable when the grade is 3 or more.

TABLE 7

| | | | | | | Fixable |
|---|---|---|---|---|---|---|
| | | | Lab | | | Mini- |
| | | L* | a* | b* | Preservability | mum |
| Target color | Tg | 43 to 49 | 73 to 79 | −1 to −7 | Rank | Rank |
| Comparative | 29.5 | 53.5 | 71.5 | 1.2 | 1 | 2 |
| Example 1 | | | | | | |
| Example 1 | 28.4 | 48.8 | 74.5 | −2.3 | 3 | 3 |
| Example 2 | 29.3 | 45.2 | 75.2 | −3.5 | 3 | 3 |
| Example 3 | 29.6 | 17.2 | 74.3 | −1.5 | 3 | 3 |
| Comparative | 30.4 | 55.6 | 70.3 | 3.5 | 2 | 2 |
| Example 2 | | | | | | |
| Comparative | 29.6 | 55.9 | 70.2 | 2.2 | 2 | 2 |
| Example 3 | | | | | | |
| Example 4 | 29.3 | 47.5 | 75.2 | −1.6 | 3 | 3 |
| Example 5 | 29.7 | 46.8 | 76.3 | −2.6 | 3 | 3 |
| Example 6 | 29.8 | 48.6 | 74.3 | −2 | 3 | 3 |
| Comparative | 29.2 | 52.1 | 69.5 | 1.5 | 1 | 2 |
| Example 4 | | | | | | |
| Comparative | 17.7 | 53.6 | 66.3 | 4.3 | 1 | 2 |
| Example 5 | | | | | | |
| Example 7 | 19.5 | 48.8 | 76.5 | −3.2 | 3 | 4 |
| Example 8 | 39.4 | 47.3 | 75.2 | −3.5 | 4 | 3 |
| Comparative | 43.6 | 51.6 | 71.6 | 5.5 | 4 | 2 |
| Example 6 | | | | | | |
| Example 9 | 26.5 | 43.5 | 78.6 | −6.5 | 4 | 5 |
| Example 10 | 35.6 | 46.6 | 77.5 | −3.5 | 5 | 4 |
| Example 11 | 33.5 | 44.2 | 78.5 | −2.8 | 5 | 5 |
| Example 12 | 32.3 | 45.2 | 78.8 | −3.8 | 5 | 5 |
| Example 13 | 30.6 | 43.2 | 78.1 | −3.3 | 4 | 5 |
| Example 14 | 28.5 | 44.5 | 78 | −2.5 | 2 | 5 |
| Example 15 | 29.6 | 43.2 | 78.6 | −6.9 | 5 | 5 |

TABLE 8-1

| | MBB3 parts | Part by weight of pigment per | |
|---|---|---|---|
| | by weight | 100 parts by weight of toner | Tg |
| Example 5 | 25 | 5.4 | 29.7 |
| Example 16 | 22 | 4.8 | 29.5 |
| Example 17 | 50 | 9.5 | 29.8 |
| Example 18 | 95 | 14.9 | 29.1 |
| Example 19 | 100 | 15.4 | 29.4 |

TABLE 8-2

| | Lab | | | | Fixable |
|---|---|---|---|---|---|
| | L* | a* | b* | Preservability | Minimum |
| | 43 to 49 | 73 to 79 | −1 to −7 | Rank | Rank |
| Example 5 | 46.8 | 76.3 | −2.6 | 3 | 3 |
| Example 16 | 49.3 | 72.3 | 0.5 | 2 | 4 |
| Example 17 | 45.3 | 77.1 | −4.2 | 3 | 3 |
| Example 18 | 43.1 | 79.1 | −6.2 | 3 | 3 |
| Example 19 | 42.5 | 80.5 | −8.1 | 4 | 2 |

TABLE 9-1

| | Parts by weight of | Parts by weight of | |
|---|---|---|---|
| | amorphous resin A3 | crystalline resin B1 | Tg |
| Example 2 | 100 | 20 | 29.3 |
| Example 20 | 70 | 50 | 26.1 |
| Example 21 | 40 | 80 | 22.6 |
| Example 22 | 20 | 100 | 19.3 |

TABLE 9-2

| | Lab | | | | Fixable |
|---|---|---|---|---|---|
| | L* | a* | b* | Preservability | Minimum |
| | 43 to 49 | 73 to 79 | −1 to −7 | Rank | Rank |
| Example 2 | 45.2 | 75.2 | −3.5 | 3 | 3 |
| Example 20 | 44.3 | 75.6 | −4.6 | 4 | 4 |
| Example 21 | 43.8 | 76.3 | −5.6 | 4 | 5 |
| Example 22 | 43.3 | 78.2 | −6.9 | 5 | 5 |

Having now fully described the invention, it will be apparent to one of ordinary skill in the art that many changes and modifications can be made thereto without departing from the spirit and scope of the invention as set forth therein.

What is claimed is:

1. A magenta toner, comprising:
a binder resin comprising an amorphous resin;
a magenta pigment comprising a naphthol pigment; and
a release agent,
wherein the magenta toner has a glass transition temperature of from 19 to 40° C., the naphthol pigment has an X-ray diffraction pattern having plural peaks in the following range:
0°≦2θ≦35°
wherein θ is a Bragg angle, and
wherein the sum of half widths of the respective peaks is from 5 to 10°.

2. The magenta toner of claim 1, wherein the binder resin further comprises a crystalline resin.

3. The magenta toner of claim 1, wherein the magenta pigment is Pigment Red 269 (PR269).

4. The magenta toner of claim 3, wherein the toner comprises the pigment PR269 in an amount of from 5 to 15 parts by weight.

5. The magenta toner of claim 1, wherein the toner comprises a core shell structure comprising:
a core comprising:
an amorphous resin,
a crystalline resin,
a magenta pigment comprising a naphthol pigment, and
a release agent, and
a shell;
wherein the shell has a glass transition temperature of from 40 to 110° C.

6. A developer for electrophotography, comprising:
the magenta toner according to claim 1; and
a carrier.

7. A toner cartridge for electrophotography, comprising the magenta toner according claim 1.

8. An image forming apparatus, comprising the toner cartridge for electrophotography according to claim 7.

9. A printed matter, comprising a glossy paper having a glossiness not less than 20%, an image formed on which by an electrophotographic process at an adherence amount of 0.30 mg/cm² or less with the magenta toner according to claim 1 has L* of from 43 to 49, a* of from 73 to 79 and b* of from −7 to −1 in CIE Lab, wherein the glossiness is measured by a gloss meter from NIPPON DENSHOKU INDUSTRIES CO., LTD. at an incident angle of 60°.
